(19) United States
(12) Patent Application Publication
(10) Pub. No.: US 2026/0195179 A1
(43) Pub. Date: Jul. 9, 2026

(54) DYNAMIC CREATION OF SECONDARY WORKFLOW FOR PRIMARY WORKFLOW

(71) Applicant: International Business Machines Corporation, Armonk, NY (US)

(72) Inventors: Jacob Ryan Jepperson, ROCHESTER, MN (US); Jennifer M. Hatfield, Austin, TX (US); Sarbajit K. Rakshit, Kolkata (IN); Carolina Garcia Delgado, Guadalajara (MX)

(21) Appl. No.: 19/008,883

(22) Filed: Jan. 3, 2025

(51) Int. Cl. G06F 9/50

(52) U.S. Cl. CPC G06F 9/5027

(57) ABSTRACT

An example operation includes one or more of detecting an event associated with a primary workflow that comprises a sequence of operations performed by at least one machine, spawning an instance of a digital twin of the primary workflow based on execution of an executable model of the digital twin and executing a simulation of the primary workflow with the digital twin through a software application based on metadata of the primary workflow, determining that an operation from among the sequence of operations comprises an anomaly based on results output by the simulation, generating a secondary workflow that includes one or more operations to be used in place of the operation that comprises the anomaly, and sending instructions to the primary workflow to branch to the one or more operations of the secondary workflow from the sequence of operations.

### BACKGROUND

Workflow management software can be used to perform a sequence of steps referred to as a workflow. In various workflows, situations can arise which lead to safety issues, failure to meet key performance indicators (KPIs), etc.

### SUMMARY

One example embodiment provides a method that includes one or more of detecting an event associated with a primary workflow that comprises a sequence of operations performed by at least one machine, spawning an instance of a digital twin of the primary workflow based on execution of an executable model of the digital twin and executing a simulation of the primary workflow with the digital twin through a software application based on metadata of the primary workflow, determining that an operation from among the sequence of operations comprises an anomaly based on results output by the simulation of the primary workflow, generating a secondary workflow that includes one or more operations to be used in place of the operation that comprises the anomaly, and sending instructions to the primary workflow to branch to the one or more operations of the secondary workflow from the sequence of operations prior to the sequence of operations reaching the operation that comprises the anomaly.

Another example embodiment provides a computer system that includes a processor set, one or more computer-readable storage media, and program instructions stored on the one or more computer-readable storage media to cause the processor set to perform operations that include one or more of detecting an event associated with a primary workflow that comprises a sequence of operations performed by at least one machine, spawning an instance of a digital twin of the primary workflow based on execution of an executable model of the digital twin and executing a simulation of the primary workflow with the instance of the digital twin through a software application based on metadata of the primary workflow, determining that an operation from among the sequence of operations comprises an anomaly based on results output by the simulation of the primary workflow, generating a secondary workflow that includes one or more operations to be used in place of the operation that comprises the anomaly, and sending instructions to the primary workflow to branch to the one or more operations of the secondary workflow from the sequence of operations prior to the sequence of operations reaching the operation that comprises the anomaly.

A further example embodiment provides a computer program product that includes one or more computer-readable storage media, and program instructions stored on the one or more computer-readable storage media to perform operations that include one or more of detecting an event associated with a primary workflow that comprises a sequence of operations performed by at least one machine, spawning an instance of a digital twin of the primary workflow based on execution of an executable model of the digital twin and executing a simulation of the primary workflow with the instance of the digital twin through a software application based on metadata of the primary workflow, determining that an operation from among the sequence of operations comprises an anomaly based on results output by the simulation of the primary workflow, generating a secondary workflow that includes one or more operations to be used in place of the operation that comprises the anomaly, and sending instructions to the primary workflow to branch to the one or more operations of the secondary workflow from the sequence of operations prior to the sequence of operations reaching the operation that comprises the anomaly.

### BRIEF DESCRIPTION OF THE DRAWINGS

FIG. 1 is a diagram illustrating a computing environment according to an embodiment of the instant solution.

FIG. 2A is a diagram illustrating a simulation of a primary workflow being triggered according to an embodiment of the instant solution.

FIG. 2B is a diagram illustrating a process of generating a secondary workflow based on the primary workflow according to an embodiment of the instant solution.

FIG. 2C is a diagram illustrating a process of modifying the primary workflow based on the secondary workflow according to an embodiment of the instant solution.

FIG. 3A is a diagram illustrating an example of a primary workflow according to an embodiment of the instant solution.

FIG. 3B is a diagram illustrating an example of a modified workflow according to embodiments of the instant solution.

FIG. 3C is another diagram illustrating an example of a modified workflow according to embodiments of the instant solution.

FIG. 4A is a flow diagram illustrating a method according to examples and features of the instant solution.

FIG. 4B is a flow diagram illustrating a method according to additional examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The example embodiments are directed to a predictive workflow modification system that aims to address the challenges created by shortcomings in workflows by dynamically adapting workflows, ensuring resource optimization, and meeting safety standards, ultimately enhancing overall industrial workflow efficiency and KPI compliance.

The system described herein may analyze a primary workflow in real-time and simulate future workloads to forecast execution performance of the workflow in the future. The system can dynamically design and execute a secondary workflow to address shortcomings that are expected to occur in the primary workflow, focusing on safety, required resources, capabilities, and capacities. Both the primary workflow and secondary workflow can be merged or otherwise combined in a manner that enables the primary workflow to operate in an improved manner.

For example, the system may generate a digital twin of a primary workflow and analyze the primary workflow in real-time and in the future by simulating workloads to forecast execution performance. As part of this process, the system may dynamically design and execute a secondary workflow to address a predicted degradation or deficiency in the primary workflow, for example, for improving safety, required resources, capabilities, capacities, and the like. Both the primary workflow and the secondary workflow may be simulated and compared to similar KPIs.

When any activity of a primary workflow needs to be executed, the system may detect this upcoming activity, for example, by using sensor data, a physical trigger, software, and the like, and generate a digital twin simulation of the activity within the primary workflow sequence, and based on the simulated results of the digital twin, the system may identify the types of capabilities and capacities required to execute the activity as per the defined KPIs. Thus, the system may be used to predict gaps in the capabilities and capacities of the participating resources allocated to execute in the primary workflow.

In some embodiments, the digital twin simulation may receive input on the specifications of the primary workflow and a defined safety policy. It may then identify required configurations and assess the health of participating machines to ensure necessary safety measures for users and systems involved in the workflow, and the like. In some embodiments, the digital twin simulation may receive input of the specifications of allocated machines, any external anomalies, specification of the steps of the primary workflow and evaluate the types and magnitude of various resources that will be required, such as battery power, coolant, secondary machining with capabilities, to execute the primary workflow.

In some embodiments, the system may dynamically adapt or modify the execution sequence of the primary workflow. For example, the system may incorporate a secondary workflow into the primary workflow (e.g., a branch, etc.). The system may continuously evaluate the progress of the primary workflow as per the defined KPI and may identify whether the adaptation of a secondary workflow is necessary to align with the progress of the execution of the primary workflow.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The dynamic workflow modification system described herein may be integrated into computer code such as a software application, a service, or the like, which is hosted by a host platform such as a cloud platform, a web server, a database, or the like.

Computing environment 100 contains an example of an environment for the execution of at least some of the computer code involved in performing the inventive methods, such as a dynamic workflow modification system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

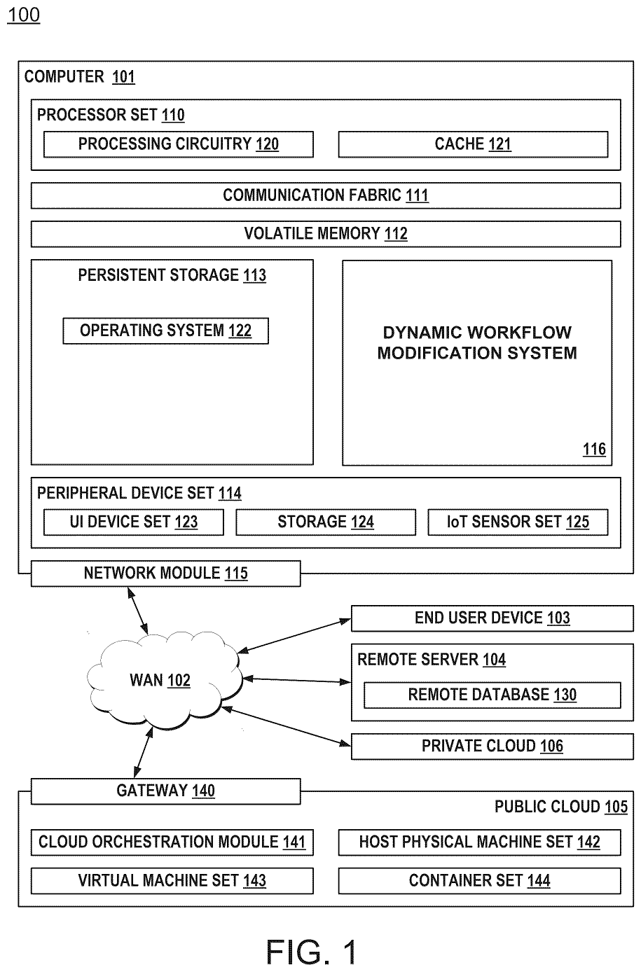

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not Separately Shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The example embodiments are directed to a system, such as a software application, which analyzes a primary workflow through a digital twin simulation. The simulation can be used to forecast performance of the primary workflow and to identify gaps in capabilities, capacities, anomalies, and resources required for executing the primary workflow. In this way, the system can predict performance issues of the workflow and take steps to proactively overcome these issues through the use of a secondary workflow that can be used to amend, repair, or otherwise, merge with the primary workflow to address the issues.

As described herein, a digital twin is a virtual representation (digital replica) of a real-world workflow. However, the digital twin is executed in a virtual space instead of in a physical space/real-world. The digital twin may receive sensor data, digital data, and the like, from the real-world version of the process, historical data of the process, and the like, and simulate a future state of the process in virtual space. The solution described herein may utilize a software program that is designed to simulate the digital twin of the process.

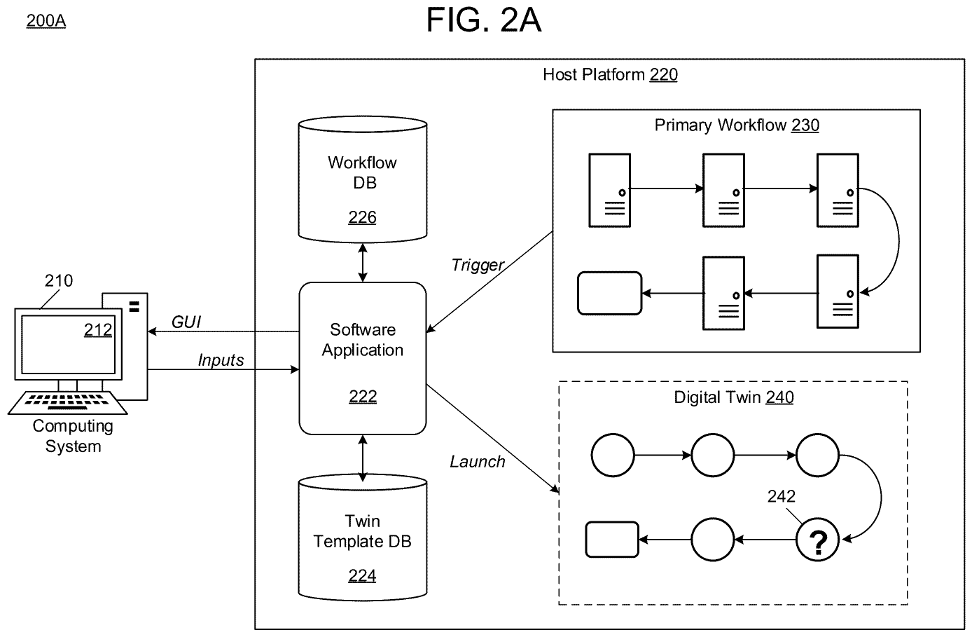

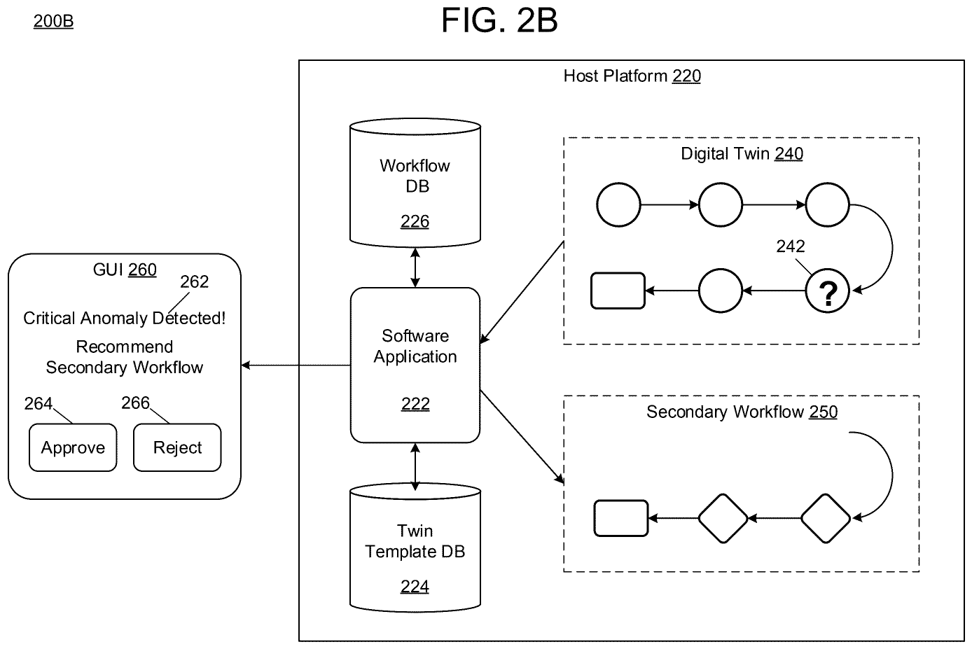

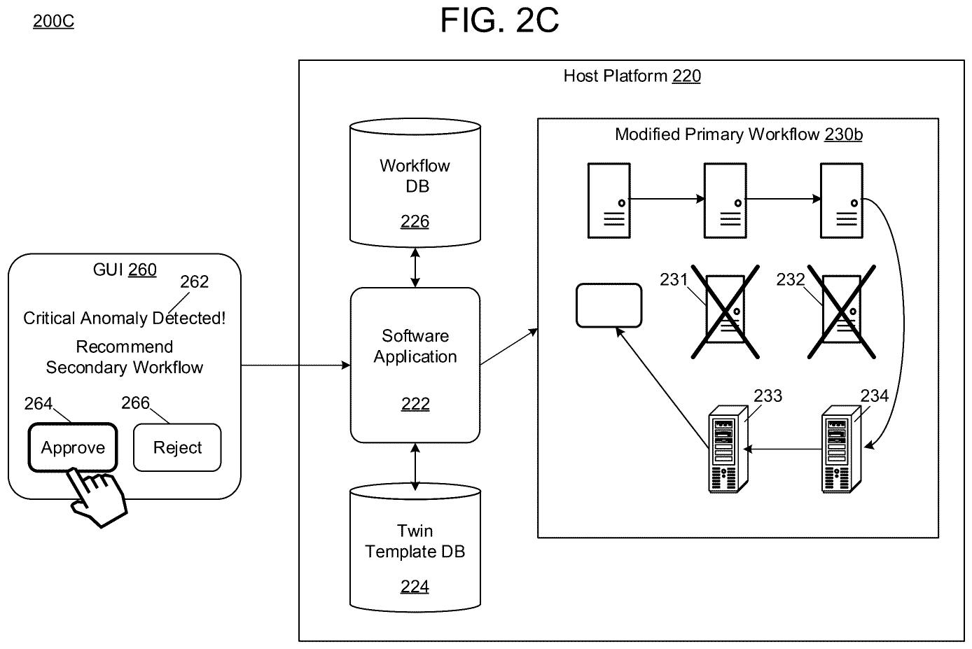

FIG. 2A illustrates a process 200A of a simulation of a primary workflow 230 being triggered according to an embodiment of the instant solution. Referring to FIG. 2A, a host platform 220 may host a software application 222 for improving the performance of the primary workflow 230. The software application 222 may dynamically modify the primary workflow 230 to prevent inefficient operation, downtime, safety problems, and the like. In this example, the host platform 220 may be a cloud platform, a web server, a distributed system of nodes, a combination of systems, and the like. The software application 222 may be a publicly available software application such as a progressive web application (PWA), a mobile application, or the like. As just one example, the software application 222 may be accessed by a computing system 210 that is connected to the host platform 220 over a network. A user may enter an IP address or web address of the software application 222 into a browser installed on the computing system 210 which causes the browser to navigate to a page or pages of the software application 222 hosted by the host platform 220.

The primary workflow 230 may refer to one or more machines, systems, computers, and the like, which perform a sequence of steps, actions, etc. that are controlled by a workflow management software system such as the software application 222. The software application 222 may control and coordinate interactions amongst the machines, systems, computers, etc. within the primary workflow 230. For example, the software application 222 may send instructions to the machines, systems, computers, etc. over a computer network.

In this example the software application 222 may detect a trigger associated with the start of the operation of the primary workflow 230, and automatically launch a digital twin 240 of the primary workflow 230. For example, the software application 222 may receive an input on a graphical user interface (GUI) with a request to start operation of the primary workflow 230. As an example, the GUI may be displayed on a display device 212 of the computing system 210 and a user may enter commands for controlling the primary workflow 230 into the GUI on the display device 212. As another example, Internet-of-Things (IoT) sensors installed in and around the systems, machines, computers, etc. within the primary workflow 230 may capture sensor data that indicates a start of the primary workflow 230. Other triggers are also possible. For example, if the primary workflow 230 is on a schedule, the scheduled start time may be provided to the software application 222.

The trigger may be detected by the software application 222 and may be used to start the digital twin 240 to proactively predict how the primary workflow 230 will perform. The digital twin 240 may be a simulation of the primary workflow 230 including a simulation of the execution times, performance, availability, and the like, of the machines, systems, computers, and the like, which are included within the primary workflow 230. Here, the software application 222 may use a digital twin template of the primary workflow 230 from a twin template database 224, and spawn an instance of the digital twin 240 within the software application 222 using the digital twin template and workflow data from a workflow database 226. To spawn the instance of the digital twin 240, the software application 222 may execute an executable file which contains the model of the digital twin 240, and add workflow data to the digital twin 240 as it runs.

The workflow data may include metadata of the primary workflow 230 such as historical execution data of the primary workflow 230, parameters of the primary workflow 230, attributes of the primary workflow 230, and the like. Operational data of the primary workflow 230 may be captured by sensors, software, and the like, during live runtime of the primary workflow 230 and stored within the workflow database 226. For example, the data captured and/or stored may include information on which nodes, machines, systems, computers, etc. perform which tasks, attributes of the nodes such as temperature data, execution time data, alerts, warnings, and the like, and other attributes of the primary workflow.

The software application 222 may obtain historical execution data of the primary workflow 230 from the workflow database 226. Here, the software application 222 may identify every step of the primary workflow 230 that is to be executed. For example, the software application 222 may identify primary workflow components, stages, interactions, dependencies, and the like. The software application 222 may identify the machines, robots, computing system, cloud services and the like, which are participating to execute the primary workflow 230.

The twin template database 224 may have a digital twin model of each and every machine, service, system, and the like, which are to be participating in the workflow execution and will also be identifying the workflow sequences. Through this, the software application 222 may create the digital twin 240 (e.g., a simulation model, etc.) representing the real-world workflow. In this case, the digital twin 240 will accurately reflect the processes, dependencies, and resources involved. The software application 222 may receive the digital twin simulation parameters, including time frames, input variables, and performance metrics, KPIs, safety parameters, etc. and input these parameters into the simulation process.

Once the digital twin 240 of the primary workflow 230 is created, the software application 222 may simulate the digital twin 240 to predict or otherwise forecast the performance of the primary workflow 230. The software application 222 may run the simulation to emulate the primary workflow 230 and analyze how the digital twin 240 responds to various inputs and scenarios. The software application 222 may evaluate performance metrics such as efficiency, cycle time, resource utilization, safety parameters, and may evaluate the same with the defined KPIs. Based on the evaluation, the software application 222 will then identify areas where the digital twin 240 deviates from optimal or expected performance.

The software application 222 may compare simulation results against predefined benchmarks or desired performance levels to identify gaps in capabilities, capacities, and resource allocation. The software application 222 may perform trial-and-error changes during the simulation to determine which additional capabilities, capacities, and resources are needed for effective execution of the primary workflow. The software application 222 may identify various gaps in the primary workflow, and through trial-and-error, will perform diverse strategies by which the identified gaps can be mitigated. Based on trial-and-error digital twin simulation, the software application 222 may identify what types of adjustments are to be performed in the primary workflow, which can include resource allocation, or capacity planning etc.

FIG. 2B illustrates a process 200B of generating a secondary workflow 250 based on the simulation results of the primary workflow 230 according to an embodiment of the instant solution. Referring to FIG. 2B, while executing the digital twin 240 of the primary workflow 230, the software application 222 may determine if any anomalies exist and whether such anomalies can be proactively prevented or otherwise addressed through modifications to the primary workflow 230. For example, the software application 222 may determine that a machine, computer, system, etc. may have performance issues, may be offline, may be unavailable, or the like, based on the simulation of the digital twin 240, and identify a modification to the primary workflow 230 that can be used to address the situation. Here, the software application 222 may dynamically generate a secondary workflow 250 to compensate for the issue in the primary workflow 230.

For example, the simulation of the digital twin 240 may result in a node 242 within the digital twin 240 corresponding to a system in the primary workflow 230 having trouble with maintaining execution time. As a result, the node 242 may cause the entire primary workflow 230 to fail to meet certain required KPIs. In response, the software application 222 may determine a secondary workflow 250 (e.g., additional machines, systems, computers, activities, etc.) that can be performed to compensate for, replace, or otherwise correct the trouble with the simulated primary workflow caused by the node 242.

In the example of FIG. 2B, the software application 222 may output content to a graphical user interface (GUI) 260 which can be viewed on the display device 212 of the computing system 210. In some embodiments, the GUI 260 may include a notification 262 of any issues that are detected with the primary workflow 230, as well as a recommendation for modifying the primary workflow 230 with a secondary workflow 250. Here, the software application 222 may provide input mechanisms 264 and 266 which can be used by a user to input commands to the software application 222 to control whether the primary workflow 230 is modified by the secondary workflow 250.

For example, the software application 222 may consider the identified gaps in capabilities, capacities, and resources required for executing the primary workflow 230 which are identified from the digital twin simulation, and use the same in designing the secondary workflow 250. Here, the software application 222 may obtain operational data of other machines, systems, computers, etc. which are available to participate in the primary workflow from the workflow database 226, and use this data to design a secondary workflow. The software application 222 may utilize the results of the gap analysis from the primary workflow 230 and identify specific shortcomings, challenges, and areas for improvement in capabilities, capacities, and resource allocation. Based on the identified gap, the software application 222 may determine if the machines, devices, resources to perform the activity can be preconfigured with the additional capabilities, capacities, and can perform the activity and identify the effectiveness of the primary workflow, like proper utilization of resources, unused capacities etc. The software application 222 may assess the deployment of additional capacities and evaluate the overall effectiveness of the primary workflow.

The software application 222 may perform comparative evaluation between intermediate deployment of additional resources, capacities, capabilities with the primary workflow 230 or additional resources, capacities, capabilities are to be deployed at the initial state of the primary activity, and if the software application 222 identifies intermediate gap mitigation is effective, then the software application 222 may design the secondary workflow 250. The purpose of the secondary workflow 250 is to support the primary workflow 230 by providing necessary capacities, capabilities, and resources, aligning its objectives with mitigating the identified gaps. The secondary workflow 250 may provide required mitigation to the primary workflow 230 by providing required improvements, resource reallocation, or capacity enhancements. The software application 222 may redesign the secondary workflow 250 to incorporate the digital twin solution simulation results and the collaboration between the primary and secondary workflow will ensure the required KPIs of the primary workflow. While the primary workflow 230 is being executed, the secondary workflow 250 may be used to allocate required resources, capacities, capabilities to the primary workflow.

FIG. 2C illustrates a process 200C of modifying the primary workflow based on the secondary workflow according to an embodiment of the instant solution. Referring to FIG. 2C, a user may press on the input mechanism 264 to approve of the modification of the primary workflow 230. In response, the software application 222 may modify the primary workflow 230 based on the secondary workflow 250 to generate a modified primary workflow 230b. The modified primary workflow 230b may include a removal of machines 231 and 232 from the existing workflow, and addition of new machines 233 and 234 from the secondary workflow.

The software application 222 may change the sequence of steps that are performed in the primary workflow, the machines, systems, nodes, etc. that perform the steps, and the like, to generate the modified primary workflow 230b. The software application 222 may also control execution of the modified workflow 230b, for example, by controlling and coordinating execution of the steps of the primary workflow through the machines, systems, computers, etc. of the modified primary workflow 230b.

The software application 222 may simulate the digital twin 240 of the primary workflow using safety policies, machine specifications, and the like, and assess health and performance of the systems, machines, and computers, ensuring safe and efficient execution. In some embodiments, the software application 222 may have a safety policy server, where safety policies will be stored. The digital twin 240 may receive the safety policies and protocols into the digital twin simulation.

The software application 222 may have defined safety measures, guidelines, and procedures that align with regulatory standards and organizational requirements. The software application 222 may identify the critical machine specifications required for the execution of the primary workflow. It may consider factors such as machine capacity, speed, accuracy, and compatibility with other workflow components. The software application 222 may have specified health parameter defined for the machines involved in the primary workflow, which includes factors like temperature, pressure, vibration, and any other relevant parameters that impact machine performance and safety.

The software application 222 may simulate the primary workflow in a realistic environment that incorporates safety policies and machine specifications. It may evaluate scenarios that test adherence to safety protocols and assess the impact of machine health on overall performance. Additionally, it may simulate safety incidents and emergencies to evaluate the effectiveness of safety procedures, such as temperature controls and hazardous work protocols. The digital twin simulation may use safety parameters to identify gaps in capacity, capabilities, and resources required for the primary workflow.

Upon approval, the software application 222 may coordinate the integration of the primary workflow 230 and the secondary workflow 250, creating a modified workflow 230b where the secondary workflow supports the primary workflow's execution. Once the secondary workflow is designed, the software application 222 may ensure seamless collaboration for optimal performance. For example, it may transmit instructions to the systems and machines involved, synchronizing activities between the primary and secondary workflows.

Based on the identified gaps in the primary workflow and the design of the secondary workflow, the software application 222 may outline the dependencies between them. It may identify specific tasks in the primary workflow that need support from the secondary workflow. The software application 222 may establish a communication protocol for messaging, data transfer, and manufacturing updates between the workflows. The systems in the primary and secondary workflows may share information and updates. The secondary workflow can anticipate when the primary workflow requires additional resources, capacities, or capabilities and provide them as needed.

For example, the software application 222 may send instructions to the systems in both the primary and secondary workflows to facilitate seamless integration. These instructions may include data sharing between the workflows, message transfers, and the exchange of network and security credentials to enable connectivity.

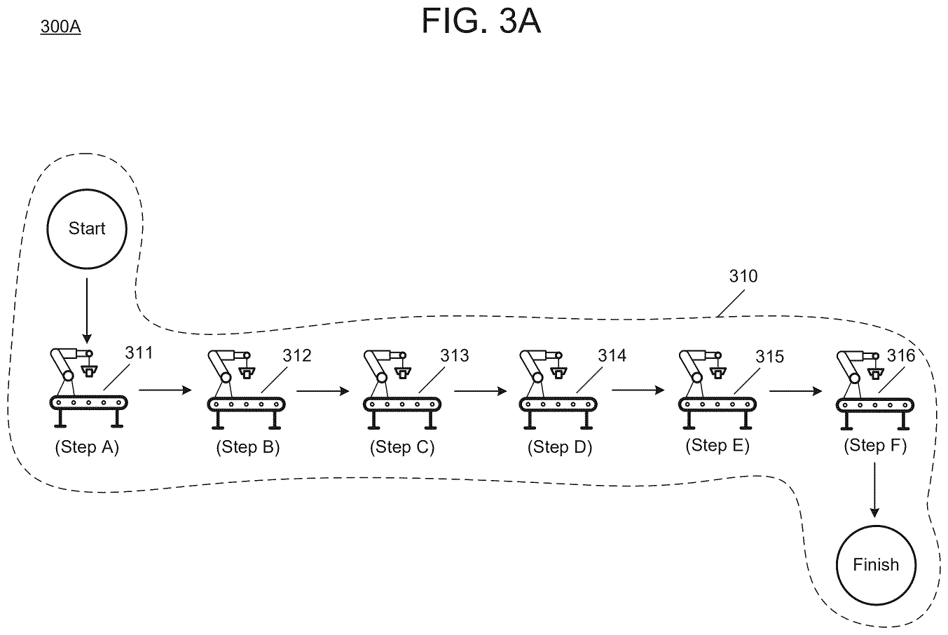

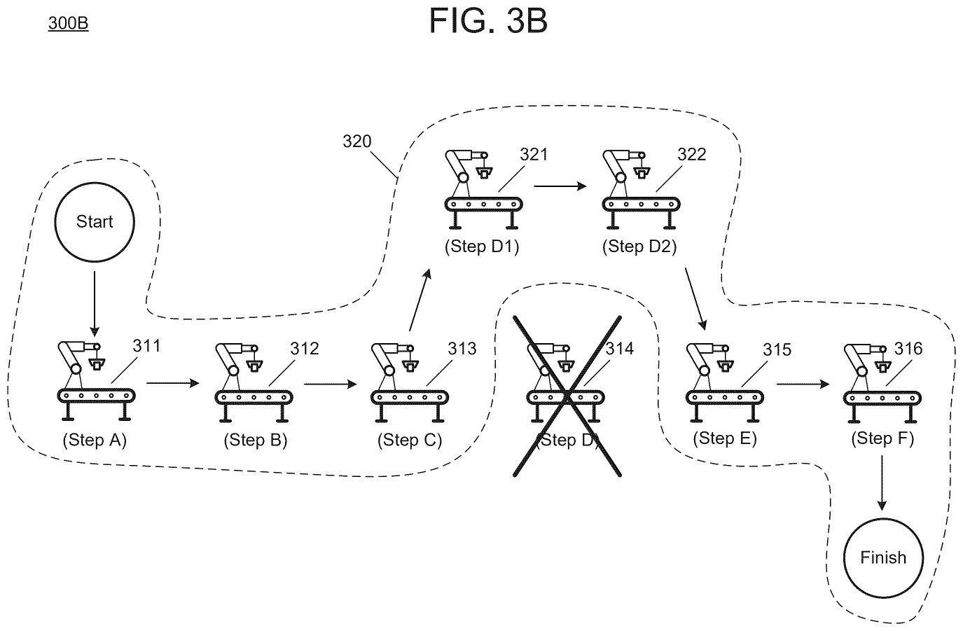

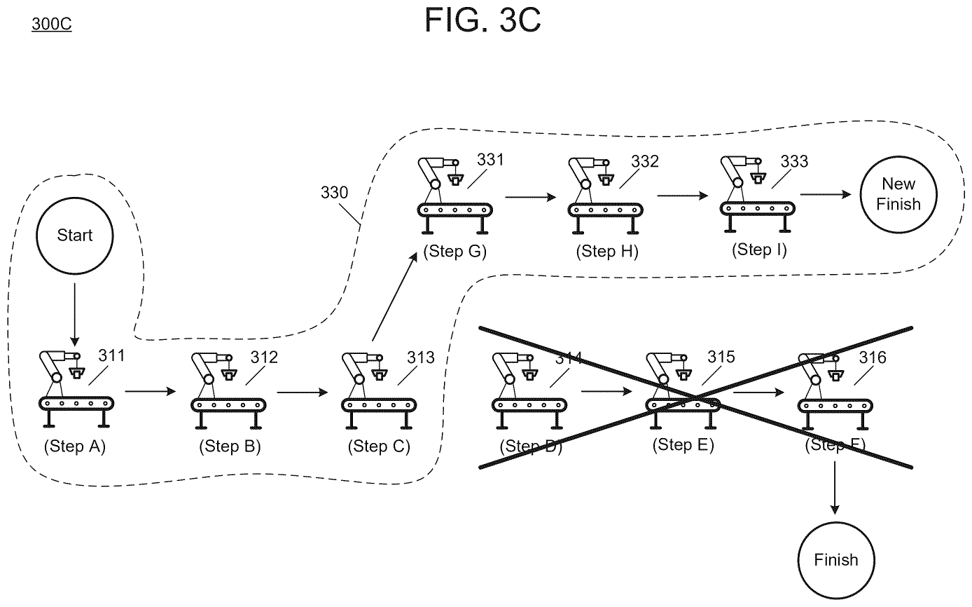

FIG. 3A illustrates a view 300A of a primary workflow 310 according to an embodiment of the instant solution, and FIGS. 3B and 3C illustrate views 300B and 300C of modified workflows, respectively, according to embodiments of the instant solution.

Referring to FIG. 3A, the view 300A of the primary workflow 310 corresponds to a manufacturing workflow. In this example, the primary workflow includes a plurality of machines that operate on an item being manufactured in sequence. Here, the sequence of operations is performed by machines 311, 312, 313, 314, 315, and 316, in sequence. Each step involves certain operations that are performed by the machines. As the primary workflow 310 starts, the item starts at the machine 311, then it is transferred to the machine 312, then to the machine 313, then to the machine 314, then to the machine 315, then to the machine 316, where the manufacture of the item is completed.

According to various embodiments, the system described herein may receive a trigger indicating that the primary workflow 310 is about to start, has already started, or the like. In response, the system may spawn an instance of a digital twin of the primary using a model stored within a model repository, and simulate the digital twin of the primary workflow 310 to perform activities and detect anomalies within the primary workflow 310 during the simulation. In some cases, the primary workflow 310 can be repaired and the task can continue to be performed by the primary workflow 310 (e.g., the manufacture of the item, etc.) As another example, the primary workflow 310 may not be capable of being repaired in which case, the system may identify a secondary purpose for the machines, systems, computers, etc. involved in the primary workflow 310 enabling productivity in some way.

Referring now to FIG. 3B, a view 300B of a modified workflow 320 is shown. The simulation of the primary workflow 310 shown in FIG. 3A, may reveal that the machine 314 has anomalies that prevent the machine 314 from meeting requirements of the primary workflow 310, for example, execution times, KPIs, safety requirements, or the like. However, the system may detect that other machines are available to address the problems with the machine 314 and repair the primary workflow 310. For example, available machine data may be stored and registered with the system. In response, the system may design a secondary workflow that includes a machine 321 and a machine 322 which can perform operations to replace the operations performed by the machine 314.

In this case, the system may modify the primary workflow to direct the machine 313 to output the item to the machine 321 instead of the machine 314. In addition, the system may modify the machine 321 to output the item to the machine 322, and the machine 322 to output the item to the machine 315, thus removing the machine 314 from the primary workflow 310 to generate the secondary workflow 320. The resulting secondary workflow 320 may be more efficient than the primary workflow 310 and may fix any of the issues caused by the system 314.

Referring now to FIG. 3C, a view 300C of a modified workflow 330 is shown. In this example, the system determines that an anomaly exists with machine 314 that prevents the operation of the primary workflow 310 from completing in a manner that satisfies the KPIs required by the primary workflow 310. Accordingly, the system may attempt to identify a fix to the issues caused by the machine 314. If it is not possible to fix the issues, the system may generate a secondary workflow to enable a portion/partial set of machines in the primary workflow to continue to operate in a productive manner. Here, the system may generate a secondary workflow that includes machines 331, 332, and 333, that can be used to replace machines 314, 315, and 316, thereby enabling the remainder of the primary workflow to continue to operate in a productive manner to manufacture a different item.

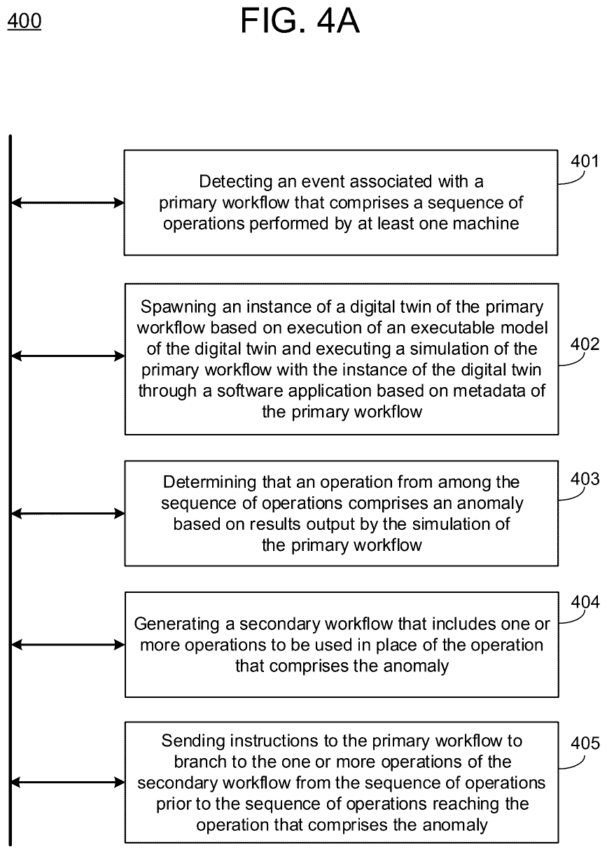

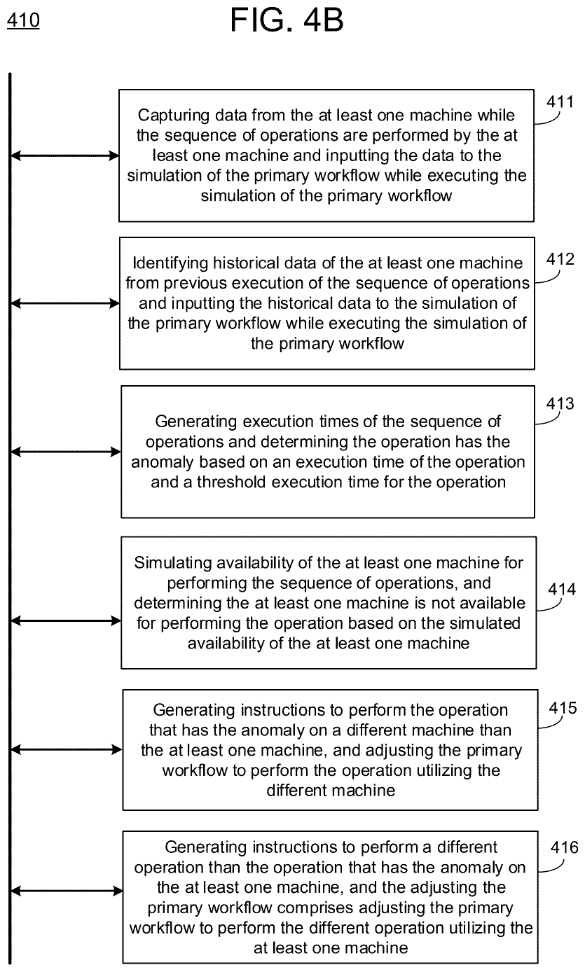

FIG. 4A illustrates a flow diagram of a method 400, according to example embodiments. Referring to FIG. 4A, in 401, the method may include detecting an event associated with a primary workflow that comprises a sequence of operations performed by at least one machine. In 402, the method may include spawning an instance of a digital twin of the primary workflow based on execution of an executable model of the digital twin and executing a simulation of the primary workflow with the instance of the digital twin through a software application based on metadata of the primary workflow. In 403, the method may include determining that an operation from among the sequence of operations comprises an anomaly based on results output by the simulation of the primary workflow. In 404, the method may include dynamically generating a secondary workflow that includes one or more operations to be used to replace the operation that comprises the anomaly. In 405, the method may include sending instructions to the primary workflow to branch to the one or more operations of the secondary workflow from the sequence of operations prior to the sequence of operations reaching the operation that comprises the anomaly.

FIG. 4B illustrates a flow diagram of a method 410, according to example embodiments. Referring to FIG. 4B, in 411, the method may include capturing data from the at least one machine while the sequence of operations is performed by the at least one machine and inputting the data to the simulation of the primary workflow while executing the simulation of the primary workflow. In 412, the method may further include identifying historical data of the at least one machine from previous execution of the sequence of operations and inputting the historical data to the simulation of the primary workflow while executing the simulation of the primary workflow. In 413, the method may include generating execution times of the sequence of operations and the determining the operation that comprises the anomaly comprises determining the operation comprises the anomaly based on an execution time of the operation and a threshold execution time for the operation.

In 414, the method may include simulating availability of the at least one machine for performing the sequence of operations, and the determining the operation that comprises the anomaly comprises determining the at least one machine is not available for performing the operation based on the simulated availability of the at least one machine. In 415, the method may include generating instructions to perform the operation that comprises the anomaly on a different machine than the at least one machine, and adjusting the primary workflow to perform the operation utilizing the different machine. In 416, the method may include generating instructions to perform a different operation than the operation that comprises the anomaly on the at least one machine, and adjusting the primary workflow to perform the different operation utilizing the at least one machine.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A method comprising:
detecting an event associated with a primary workflow that comprises a sequence of operations performed by at least one machine;
spawning an instance of a digital twin of the primary workflow based on execution of an executable model of the digital twin and executing a simulation of the primary workflow with the instance of the digital twin through a software application based on metadata of the primary workflow;
determining that an operation from among the sequence of operations comprises an anomaly based on results output by the simulation of the primary workflow;
generating a secondary workflow that includes one or more operations to be used in place of the operation that comprises the anomaly; and
sending instructions to the primary workflow to branch to the one or more operations of the secondary workflow from the sequence of operations prior to the sequence of operations reaching the operation that comprises the anomaly.

2. The method of claim 1, further comprising capturing data from the at least one machine while the sequence of operations is performed by the at least one machine and inputting the data to the simulation of the primary workflow while executing the simulation of the primary workflow.

3. The method of claim 1, further comprising identifying historical data of the at least one machine from previous execution of the sequence of operations and inputting the historical data to the simulation of the primary workflow while executing the simulation of the primary workflow.

4. The method of claim 1, wherein the executing the simulation of the primary workflow comprises generating execution times of the sequence of operations and the determining the operation that comprises the anomaly comprises determining the operation comprises the anomaly based on an execution time of the operation and a threshold execution time for the operation.

5. The method of claim 1, wherein the executing the simulation of the primary workflow comprises simulating availability of the at least one machine for performing the sequence of operations, and the determining the operation that comprises the anomaly comprises determining the at least one machine is not available for performing the operation based on the simulated availability of the at least one machine.

6. The method of claim 1, wherein the generating the secondary workflow comprises generating instructions to perform the operation that comprises the anomaly on a different machine than the at least one machine, and the adjusting the primary workflow comprises adjusting the primary workflow to perform the operation utilizing the different machine.

7. The method of claim 1, wherein the generating the secondary workflow comprises generating instructions to perform a different operation than the operation that comprises the anomaly on the at least one machine, and the adjusting the primary workflow comprises adjusting the primary workflow to perform the different operation utilizing the at least one machine.

8. A computer system comprising:
a processor set;
one or more computer-readable storage media; and
program instructions stored on the one or more computer-readable storage media to cause the processor set to perform operations comprising:
detecting an event associated with a primary workflow that comprises a sequence of operations performed by at least one machine;
spawning an instance of a digital twin of the primary workflow based on execution of an executable model of the digital twin and executing a simulation of the primary workflow with the instance of the digital twin through a software application based on metadata of the primary workflow;
determining that an operation from among the sequence of operations comprises an anomaly based on results output by the simulation of the primary workflow;
generating a secondary workflow that includes one or more operations to be used in place of the operation that comprises the anomaly; and
sending instructions to the primary workflow to branch to the one or more operations of the secondary workflow from the sequence of operations prior to the sequence of operations reaching the operation that comprises the anomaly.

9. The computer system of claim 8, wherein the operations further comprise capturing data from the at least one machine while the sequence of operations is performed by the at least one machine and inputting the data to the simulation of the primary workflow while executing the simulation of the primary workflow.

10. The computer system of claim 8, wherein the operations further comprise identifying historical data of the at least one machine from previous execution of the sequence of operations and inputting the historical data to the simulation of the primary workflow while executing the simulation of the primary workflow.

11. The computer system of claim 8, wherein the executing the simulation of the primary workflow comprises generating execution times of the sequence of operations and the determining the operation that comprises the anomaly comprises determining the operation comprises the anomaly based on an execution time of the operation and a threshold execution time for the operation.

12. The computer system of claim 8, wherein the executing the simulation of the primary workflow comprises simulating availability of the at least one machine for performing the sequence of operations, and the determining the operation that comprises the anomaly comprises determining the at least one machine is not available for performing the operation based on the simulated availability of the at least one machine.

13. The computer system of claim 8, wherein the generating the secondary workflow comprises generating instructions to perform the operation that comprises the anomaly on a different machine than the at least one machine, and the adjusting the primary workflow comprises adjusting the primary workflow to perform the operation utilizing the different machine.

14. The computer system of claim 8, wherein the generating the secondary workflow comprises generating instructions to perform a different operation than the operation that comprises the anomaly on the at least one machine, and the adjusting the primary workflow comprises adjusting the primary workflow to perform the different operation utilizing the at least one machine.

15. A computer program product comprising:
one or more computer-readable storage media; and
program instructions stored on the one or more computer-readable storage media to perform operations comprising:
detecting an event associated with a primary workflow that comprises a sequence of operations performed by at least one machine;
spawning an instance of a digital twin of the primary workflow based on execution of an executable model of the digital twin and executing a simulation of the primary workflow with the instance of the digital twin through a software application based on metadata of the primary workflow;
determining that an operation from among the sequence of operations comprises an anomaly based on results output by the simulation of the primary workflow;
generating a secondary workflow that includes one or more operations to be used in place of the operation that comprises the anomaly; and
sending instructions to the primary workflow to branch to the one or more operations of the secondary workflow from the sequence of operations prior to the sequence of operations reaching the operation that comprises the anomaly.

16. The computer program product of claim 15, wherein the operations further comprise capturing data from the at least one machine while the sequence of operations is performed by the at least one machine and inputting the data to the simulation of the primary workflow while executing the simulation of the primary workflow.

17. The computer program product of claim 15, wherein the operations further comprise identifying historical data of the at least one machine from previous execution of the sequence of operations and inputting the historical data to the simulation of the primary workflow while executing the simulation of the primary workflow.

18. The computer program product of claim 15, wherein the executing the simulation of the primary workflow comprises generating execution times of the sequence of operations and the determining the operation that comprises the anomaly comprises determining the operation comprises the anomaly based on an execution time of the operation and a threshold execution time for the operation.

19. The computer program product of claim 15, wherein the executing the simulation of the primary workflow comprises simulating availability of the at least one machine for performing the sequence of operations, and the determining the operation that comprises the anomaly comprises determining the at least one machine is not available for performing the operation based on the simulated availability of the at least one machine.

20. The computer program product of claim 15, wherein the generating the secondary workflow comprises generating instructions to perform the operation that comprises the anomaly on a different machine than the at least one machine, and the adjusting the primary workflow comprises adjusting the primary workflow to perform the operation utilizing the different machine.
